(19) United States
(12) Patent Application Publication
(10) Pub. No.: US 2026/0205008 A1
(43) Pub. Date: Jul. 16, 2026

(54) MODULATED OVERCURRENT LEVEL FOR VARIABLE GATE DRIVE STRENGTH

(71) Applicant: DANA TM4 INC., Boucherville (CA)

(72) Inventors: Pascal FLEURY, Sainte-Madeleine (CA); Gabriel GUILMAIN, McMasterville (CA)

(21) Appl. No.: 19/446,792

(22) Filed: Jan. 12, 2026

Related U.S. Application Data
(60) Provisional application No. 63/745,240, filed on Jan. 14, 2025.

(51) Int. Cl. H02M 1/32; B60L 15/00; H02M 7/5387

(52) U.S. Cl. CPC H02M 1/32; B60L 15/007; H02M 7/5387

(57) ABSTRACT

Methods and systems are provided for detecting an overcurrent in a power transistor of an inverter, and performing a controlled shutdown of the power transistor. An overcurrent detection circuit monitors a measured current into the power transistor, and compares it with an overcurrent detection threshold stored in a memory. If the measured current exceeds the overcurrent detection threshold, a soft turn-off is performed. When the gate drive strength is modulated, there may be moments in the switching cycle when the drive strength is too high to turn the power transistor off in cases of an isolation fault. To avoid such scenarios, the overcurrent detection threshold is dynamically modulated based on the gate drive strength. In this way, inverter efficiency is increased by using a variable gate drive strength while reducing the chance of power electronics degradation caused by overcurrent of the power transistor.

### CROSS REFERENCE TO RELATED APPLICATIONS

The present application claims priority to U.S. Provisional Application No. 63/745,240, entitled “MODULATED OVERCURRENT LEVEL FOR VARIABLE GATE DRIVE STRENGTH”, and filed on January 14, 2025. The entire contents of the above-listed application are hereby incorporated by reference for all purposes.

### FIELD

The present disclosure relates to overcurrent detection in power transistors of a power electronics module.

### BACKGROUND AND SUMMARY

Automotive electric motors used in electric vehicles and electric hybrid vehicles typically comprise one or more multiphase alternating current (AC) motors that rely on an inverter to use direct current (DC) power supplied by one or more energy storage devices, such as batteries. A rectifier may be used to convert AC power to DC power for charging the on-board batteries. Further, DC-to-DC converters may be relied on to step-up or step-down DC voltage levels within the power electronic system. Some automotive inverters include electronic switching components, such as high voltage/high current power transistors, that are controllably switched on and off in rapid sequence so as to provide multiphase AC to the electric motor. The inverters described herein may be used in a variety of fields, including but not limited to electric powertrains, renewable energy systems, backup power, portable devices, etc.

An efficiency of the power transistors may be increased by using a variable gate drive strength. Depending on an instantaneous phase current, working voltage or other condition, the drive strength to the gate may be modulated to reduce switching losses for a particular condition. In the event of an overcurrent (e.g., an increase in current applied to the power transistors above a threshold allowed current), the power transistor may be configured to turn off in a controlled manner to avoid a voltage overshoot larger than a threshold permitted voltage across its terminals. The overcurrent detection threshold may be adjusted above an upper current level that is expected under normal conditions. When the overcurrent is detected, a soft turn-off may be performed where the power transistor is gradually shut down and the magnitude of the overshoot is decreased.

However, the present inventors have recognized that when the gate drive strength is modulated, there may be moments in the switching cycle when the drive strength is too high to turn the power transistor off as desired in case of an isolation fault leading to an overcurrent. Such a fault may be for example shorted turns in the motor winding. In the event of an isolation fault, the power transistor may be turned off (e.g., a hard turn-off) before the overcurrent detection threshold is achieved. In such cases, the soft turn-off may not be performed, and the gate drive strength may be adjusted such that the voltage overshoot may exceed its maximum permitted value.

In one example, the aforementioned problems may be at least partially addressed by an integrated circuit of an inverter including a power transistor, a gate driver configured to output one of a first drive strength and a second drive strength to the power transistor, and an overcurrent detection circuit configured to interrupt a current of the power transistor in response to the current increasing above an overcurrent detection threshold. The overcurrent detection threshold is selected based on the gate drive strength selected for the particular condition of instantaneous current and working voltage. In this way, inverter efficiency is increased by using a variable gate drive strength while reducing the chance of power electronics degradation caused by overcurrent of the power transistor.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

### BRIEF DESCRIPTION OF THE DRAWINGS

FIG. 1 is a diagram of an exemplary automotive vehicle system that includes a traction battery, inverter, and traction motor.

FIG. 2 is a block diagram of the battery, inverter, and motor shown in FIG. 1.

FIG. 3 is an exemplary power module electrical schematic comprising power semiconductors in a half-bridge arrangement.

FIG. 4 is a perspective view of an exemplary power module illustrating an arrangement of power transistors for an inverter.

FIG. 5 is a flowchart illustrating a method for detecting an overcurrent in a power transistor.

FIG. 6 is a prior art graph illustrating an example of gate drive strength selection based on the instantaneous current, and the magnitude above which an overcurrent is detected and a soft turn-off is performed.

FIG. 7 is a prior art graph illustrating a fault condition where the current goes above the limit for a high strength but does not reach the detection level needed for a soft turn-off.

FIG. 8 is a graph illustrating an exemplary variable overcurrent detection threshold for detecting an overcurrent.

FIG. 9 shows two circuit diagrams of different implementations of the method of FIG. 5.

### DETAILED DESCRIPTION

It is to be understood that the disclosure may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

As mentioned, the inventors recognized that the performance of an inverter (e.g., a power control module), at least in terms of output current capacity of an electric powertrain or other suitable system, may be affected by a voltage overshoot in a power transistor the event of an isolation fault. Certain gate driver chips may have a fixed overcurrent detection threshold that may be configured, but cannot be changed during operation of the inverter. As a result, a conventional overcurrent detection framework may detect a first overcurrent generated under normal conditions (e.g., due to normal variations in current), but may not detect a second overcurrent generated by an isolation fault, when the power transistor may be commanded to turn off before the predefined overcurrent detection threshold is achieved.

To address this, systems and methods are proposed herein for modulating the overcurrent detection threshold according to a strength level of a gate driver of the power transistor. The overcurrent detection threshold may be dynamically set such that a soft turn-off (e.g., a controlled or graceful shutdown) will be performed if a current of the power transistor is too large to be safely interrupted, based on the gate drive strength used at the time the isolation fault occurs. The input current of the power transistor (drain current) is the same as the output current of the power transistor (source current). The overcurrent detection threshold may be dynamically set for various ranges of gate drive strength levels, which may be selected based on instructions stored in a memory of the vehicle and executed by a controller of the vehicle, or logic of the gate driver circuit itself. The gate drive strength levels may be selected based on various signals, such as a phase current level, a semiconductor temperature, a drain voltage of a last switching cycle, etc. In the event of an isolation fault, the proposed solution may provide greater protection of the power transistor and associated circuitry than a conventional overcurrent detection framework based on a fixed overcurrent detection threshold, regardless of a variable gate drive strength used, by providing an equally variable and synchronized OC detection level.

The disclosure addresses a challenge in power transistor systems that utilize variable gate drive strength for improved efficiency. In modern power electronics, the gate drive strength is dynamically modulated based on instantaneous phase current to minimize switching losses under different operating conditions. However, this optimization creates an issue: conventional gate driver chips employ a fixed overcurrent detection level that cannot be changed during operation. When an overcurrent is detected, the power transistor turns off in a controlled manner to prevent voltage overshoot beyond its maximum rated value. The problem arises when a fault occurs at a moment in the operational cycle where the gate drive strength is set to a level that cannot interrupt the current through a hard turn-off. If the current rises above the threshold for the active drive strength but remains below the fixed overcurrent detection level, the transistor may attempt to turn off with insufficient control, resulting in destructive voltage overshoot that can cause the power semiconductor to fail.

The proposed solution dynamically modulates the overcurrent detection level in synchronization with the gate drive strength level. Rather than maintaining a fixed threshold, the system adjusts the overcurrent detection level to match the maximum current that can be interrupted given the instantaneous gate drive strength being used. This ensures that if the current becomes too large to be desirably interrupted with a hard turn-off at the current drive strength setting, the system will trigger a soft turn-off mode where voltage overshoot remains controlled and within desired limits. The method works with any number of different drive strength levels. The selection of the demanded drive strength may originate from either the processor (e.g., controller) or the gate driver circuit itself and can be directed by multiple operational parameters including phase current level, semiconductor temperature, and drain voltage from the previous switching cycle.

The technical benefits of this disclosure are substantial. By providing an equally variable and synchronized overcurrent detection level that tracks the gate drive strength, the system protects the power transistor under all fault conditions regardless of which drive strength mode is active at the moment the fault occurs. This eliminates the risk of transistor degradation that exists when using a fixed overcurrent detection level with variable gate drive strength. Each drive strength zone is designed such that a hard turn-off can be performed on any current level within that zone, and exceeding the current threshold for any zone automatically triggers the protective soft turn-off mode. This approach allows the system to maintain the efficiency benefits of variable gate drive strength while ensuring comprehensive overcurrent protection at all times, preventing device degradation due to excessive voltage overshoot during fault conditions.

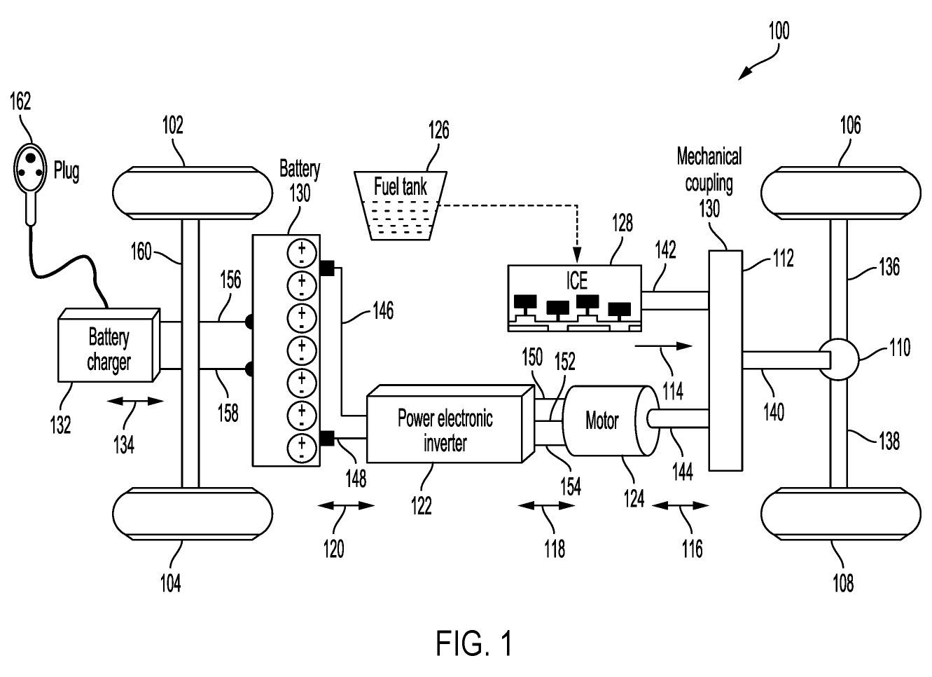

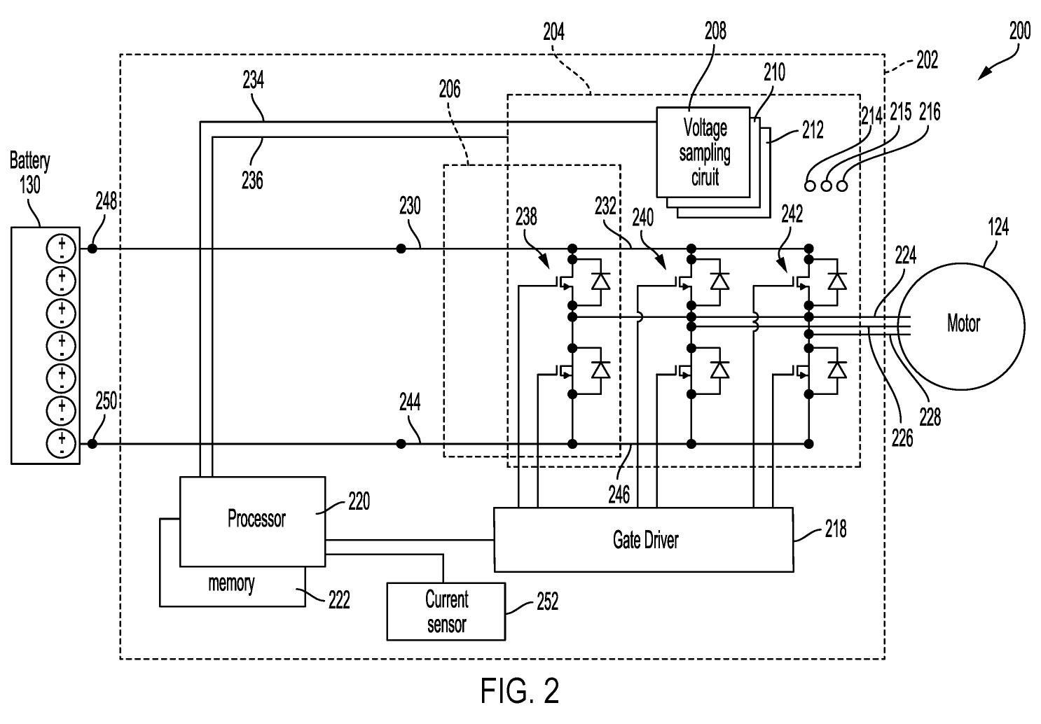

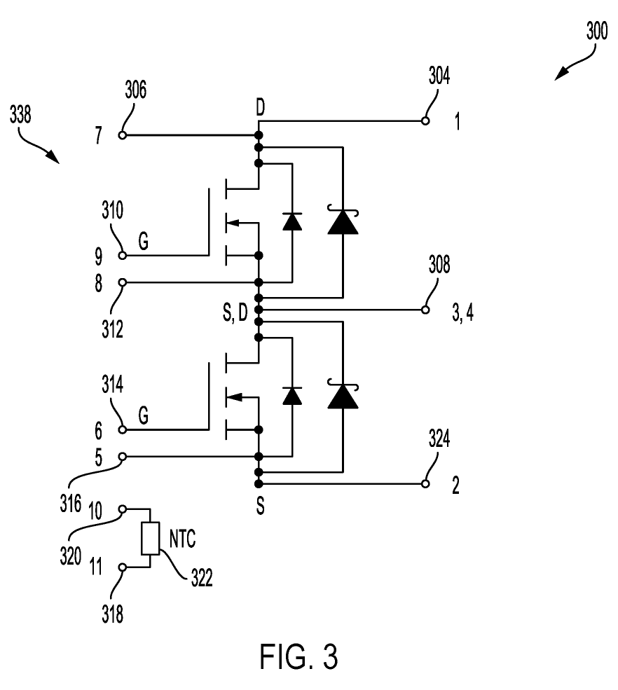

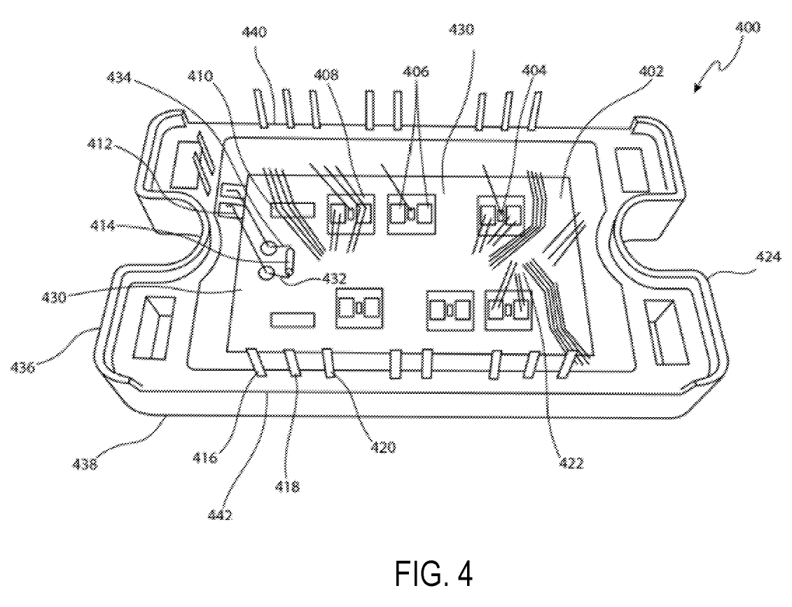

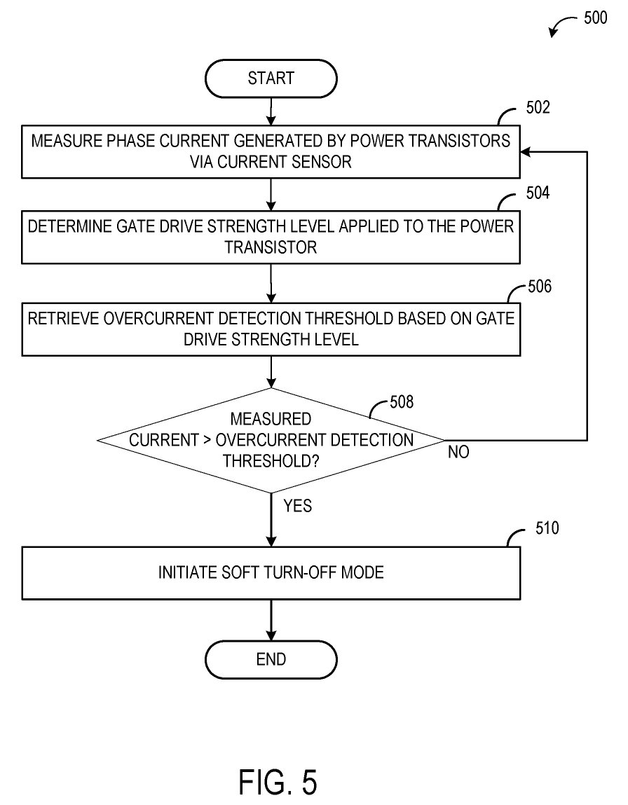

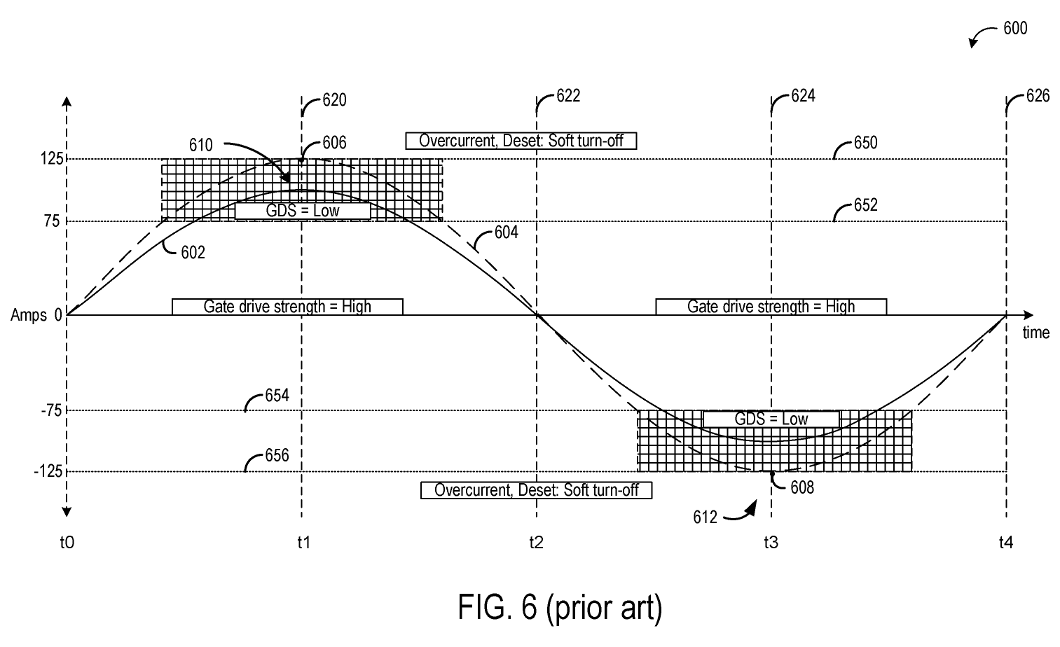

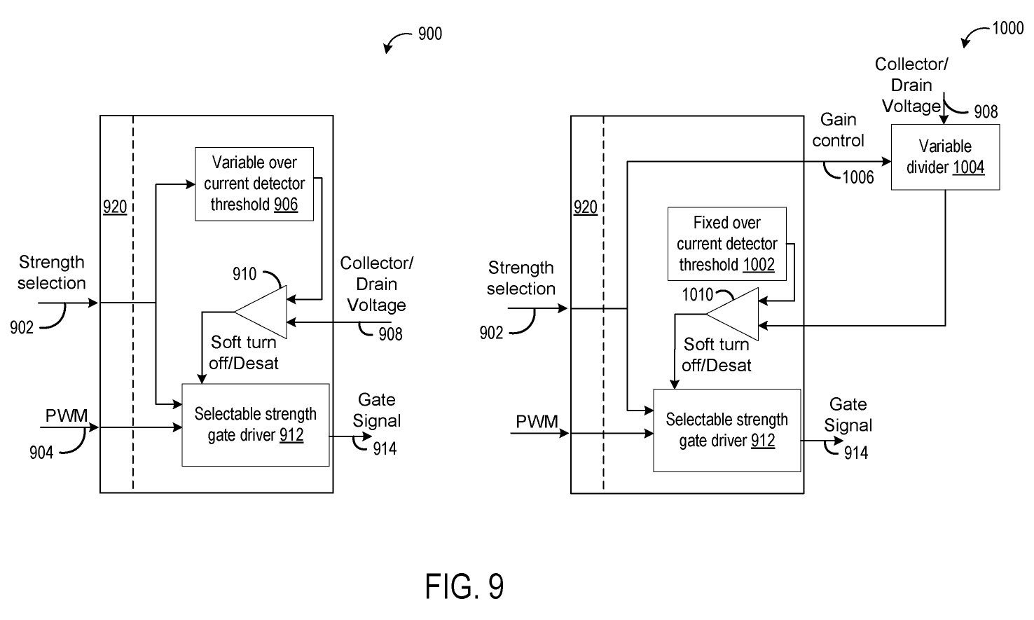

As an overview, FIG. 1 illustrates an example of a hybrid vehicle system to provide context for the described embodiments, showing a traction inverter between a traction energy storage system (battery) and a traction motor for driving the drive wheels of the vehicle. Following this, FIG. 2 presents a block diagram of a battery, inverter, and motor shown FIG. 1, according to embodiments. FIG. 3 includes an exemplary half-bridge arrangement usable in the inverter, according to embodiments. FIG. 4 shows a perspective view of an exemplary embodiment of a power module illustrating an arrangement of power transistors for an inverter. A method for detecting an overcurrent using dynamically established overcurrent detection thresholds is described in FIG. 5, which is indicated visually via the graphs of FIGS. 6-8. The method may be implemented in various ways, two of which are described in reference to FIG. 9.

FIG. 1 illustrates a vehicle 100 comprising an inverter, such as a traction inverter 122, that exchanges or communicates electrical energy with an energy storage system (such as battery 130) and exchanges electrical energy with a motor, such as traction motor 124, that, in one direction, converts the electrical energy into mechanical energy, for example rotational motion for driving the vehicle traction system, such as may be associated with and include wheels 106, 108; and that, in another direction, convers the mechanical energy, such as from the drive wheels 106, 108, to electrical energy. The present inventors recognized the importance of increasing the efficiency, reducing costs, and enhancing other characteristics of the inverter that increase the efficiency and reliability of the power electronics in the inverter, especially with respect to protecting the power transistors used in the inverter from excessive currents/voltages. As will be described in greater detail herein, the present inventors discovered improvements in overcurrent detection of the power transistors.

FIG. 1 illustrates an example hybrid vehicle system. Vehicle 100, as shown, includes a number of connected components and systems. The vehicle 100 may be charged via plug/receptacle 162, which transfers power to battery charger 132. The charger then transfers power to the energy storage system (or battery) 130 through bi-directional connection 134 comprising power linkages (or electrical conductors) 156 and 158. Power electric inverter 122 may receive power from and transfer power to the battery 130 via the bi-directional connection 120 comprising power linkages 146 and 148. The power electronic inverter 122 may likewise receive power (electrical energy) from and transfer power (electrical energy) to the electric (AC) motor 124 via bi-directional connection 118 comprising (phase current) linkages 150, 152, and 154.

A fuel tank 126 provides gasoline or other fuel to the internal combustion engine (ICE) 128. Several other topologies other than the parallel topology shown in FIG. 1 may be used, including, for example, series or parallel-series. Both the electric motor and the ICE are coupled via mechanical connections 144 and 142, respectively, to a mechanical coupling system 112 which may comprise, for example, a differential and/or gear reducer and/or other mechanical couplings adapted to receive mechanical (e.g., rotating) energy from one or both of the ICE 128 and/or traction motor 124, and transfer the mechanical energy to the vehicle drive axle assembly, such as drive shaft 140, differential 110, half shafts 136 and 138, and drive wheels 106 and 108. However, the vehicle may be designed with an all-electric powertrain where the ICE and associated system are omitted from the vehicle, in other examples.

It may be noted that the ICE 128, as shown, typically transfers power in one direction, as indicated by connection 114. The mechanical connection 144 transfers power bi-directionally, as indicated by connection 116. The mechanical coupling then transfers the power via coupling 140 to axle shafts 136 or 138. In some embodiments, the axle shafts136 and 138 may be a shaft; however, in other embodiments they may be separate half-shafts connected by a differential 110. An unpowered axle 160 may be located at the rear of the vehicle; however, axle 160 may be otherwise arranged and/or driven with drive line coupling to one or more ICE and/or motor, including ICE 128 and/or AC traction motor 124. The vehicle rides on wheels 102, 104, 106, and 108; however, drive wheels 102, 104, 106, 108 may comprise other drive traction structure (e.g., track) and may comprise a different number of drive traction structures instead of the four drive wheels shown.

FIG. 2 illustrates a battery-inverter-motor configuration 200, usable in vehicle 100 and/or other suitable system, comprising an energy storage system such as battery 130, an inverter such as inverter 202 (e.g., a traction inverter), and a motor such as traction motor 124. The inverter 202, in some embodiments, comprises an H-bridge arrangement using three pairs of, or six, power transistors, such as pairs 238, 240, and 242, connected with positive and negative electrical connections of the energy storage system (described herein as inputs to the inverter), such as terminals 248 and 250 of the battery 130, and three phase connections (described herein as outputs of the inverter), such as phase load connections 224, 226, and 228 of traction motor 124.

Although described herein as having inputs and outputs, usually in the context of DC from the battery as inputs to the inverter and AC from the inverter as outputs from the inverter (and inputs to the motor), as mentioned and shown in FIG. 1, electrical energy generated by motor 124 may be inputs to the inverter (at AC motor phase current conductors 224, 226, and 228) with the inverter 202 providing (as outputs of terminals 248, 250) electrical energy to the battery for charging the battery via the inverter 202.

Also with respect to the dashed boxes 202, 206, and 204 shown in FIG. 2, although various components and functionality may be described within a particular box, the boxes (e.g., 202, 206, 204) may comprise more or less than the functionality and components shown and described. The boxes are to assist in describing various components and functionality; however, the boxes do not limit which components or functionality might be included in, for example, the inverter (such as inverter 122). For example, although not shown, the inverter may comprise half-bridge boost DC-DC converter circuitry interposed between terminals 248 and 250 of the battery 130 and terminal/conductor connections 230 and 244. One skilled in the art will know that interposing such half-bridge boost DC-DC circuitry (to, for example, step up the voltage from the battery 130 to a higher voltage input going into the pairs of power transistors 238, 232, and 242) between terminals 248, 250 and conductor points 230, 244 necessarily replaces the continuity of conduction between the terminal positions shown in FIG. 2. For example, the interposed half-bridge boost DC-DC converter circuitry would replace the conductor between battery terminal 248 and terminal/conductor position 230. Optional half-bridge boost DC-DC circuitry will be further described with respect to FIG. 3.

Still with regard to the boxes 202, 204, and 206 in FIG. 2, various components and functionality may, in some embodiments, comprise components and functionality that may be realized in separable modules whereby some components and functionality are housed in a separate casing/housing, for example. In one embodiment, the inverter 122 may comprise the high voltage circuitry illustrated in FIG. 2, with some or all of the low voltage circuitry (e.g., processor 220, memory 222, gate driver 218, etc.) arranged in a separate module. As another example, in one embodiment, low voltage circuitry comprising the current sensor and isolation circuitry therefor, to, for example, provide operative (and electrically isolated) phase current sensing through the AC load conductors 224, 226, and 228, may be integrally disposed within circuit boards comprising the inverter 122 as opposed to a separately housed module (with separate casing/housing).

As shown in FIG. 2, gate driver circuitry 218, comprising low voltage circuitry isolated from the high voltage circuitry to and from the battery 130 and motor 124, is adapted to control the power transistors (e.g., power FETs such as MosFETs) via the six gate inputs shown within in the power transistor circuitry portion 204. Gate driver circuitry 218 may receive control signals from the processor 220, for example, to control each of the six semiconductor switching states such that, in each pair of transistors 238, 240, and 242, one transistor switch is closed (on-state, allowing current flow through the closed, high voltage/high current side of the transistor/switch) as the other transistor in the pair is open (preventing current flow through the closed transistor).

In a particular half-bridge, such as half-bridge 206, for example, one transistor in the pair (e.g., pair 238) is controllably closed while the other is controllably open such that current flows between the battery and the load (phase current conductor to the AC motor) through the closed power transistor and so that the half-bridge does not form a short between the positive conductor extending from the energy storage system/battery 130 and the negative conductor extending therefrom. In operation, the gate of each power transistor is controlled (such as by processor 220 and gate driver 218) to open and close in sequence with each of the other power transistors so as to control current flow between the battery and the motor via each of the phase current conductors 224, 226, 228. Controlling the (fast) switching of each of the power transistors in the (as shown in FIG. 2, H-bridge arrangement of six power transistors) is, therefore, of importance for high performance of the inverter and of the AC motor.

As shown in FIG. 2, the inverter 202 may include a processor 220 in communication with memory 222, the processor for controlling a gate driver 218 adapted to control a gate associated with each of the power transistors in the inverter; one or more built-in, on-board current sensors (or phase current sensors) 252 adapted to measure current in one or more of the phase current conductors 224, 226, and 228; and voltage sampling circuitry 208 adapted to sense/measure a junction voltage (or conduction voltage, or drain-source voltage (Vds) for MOSFETs, or collector-emitter voltage (Vce) or saturation voltage (Vce(sat)) for IGBTs) for one or more of the power transistors comprising the inverter. Also as shown, the voltage sampling circuitry/circuit 208 is communicably associated with circuitry and/or software routines (e.g., computer instructions saved in memory 222, for example) that provide the functionality of an isolation amplifier 210 adapted to amplify a sampled conduction voltage from the voltage sampling circuitry 208; filtering and gain 212 adapted to remove (filter) unwanted frequency content in the sampled conduction voltage data; peak detection 214 adapted to detect a peak conduction voltage; and communication 234 between the voltage sampling circuit 208 and processor 220, and/or communication 236 between circuitry and/or software/firmware associated with the isolation amplifier 210, filter and gain 212, and further circuitry and/or software functional blocks such as a peak detector 215 adapted to detect peak sampled voltage, a peak detector 216 adapted to detect peak current amplitude sensed, as well as a sequencer adapted to reset each of the voltage and current peak detectors.

Different types of power semiconductors may be used in the inverter. For example, power transistor pairs 238, 240, and 242 may each comprise a pair of insulated-gate bipolar transistors (IGBTs). As another example, the power transistor pairs 238, 240, and 242 may each comprise a pair of metal-oxide semiconductor field effect transistors (MOSFETs). Further, a different number of power transistors may be used other than the six power transistors shown in FIG. 2. For instance, the inverter 202 may comprise additional power semiconductors configured in an additional three-phase bridge arrangement of six power transistors whereby the additional six switches may be adapted with load connections to exchange electrical energy between a generator or second motor, or to provide a different power configuration. For example, one group of six switches, e.g., pairs 238, 240, and 242, may be adapted to provide 50kW power to a motor, and the other group of six switches, not shown, may be adapted to provide 30kW power to a generator. As another example, an additional pair of power transistors may be arranged in a half-bridge and included in the inverter 202 so as to replace the connections from terminal 248 to connection point 230 and from terminal 250 to connection point 244, and configured so as to provide a half-bridge boost DC-DC converter from the battery to the inverter circuitry such as circuitry 204.

Peak detector 216 may be configured to detect an overcurrent in measurements acquired by the on-board current sensors 252. The overcurrent may be a current in excess of a maximum expected current supplied to the power transistors. The overcurrent may generate an excessive voltage in voltage sampling circuitry/circuit 208 that may damage the power transistors. To prevent such damage, instructions may be stored in memory 222, or in a different memory, that when executed, cause a graceful shutdown of transistor pairs 238, 240, and 242. This may be referred to as a soft turn-off mode. The overcurrent signal may be based on the drain voltage of the power transistor, which form an image of the current in the power transistor. This voltage may be processed in the gate driver due the speed demanded for an action to occur, in one example. A drain voltage higher than the set limit will trigger a fault and also a soft turn-off request. A soft turn-off may include changing the gate voltage signal slower than other turn-off operations. Because the gate changes state at a slower speed, the transition from ON to OFF state of the power transistor is also slower. This reduces the voltage overshoot on the power transistor because it is proportional to the rate of change of the current. A slower transition makes the current change at a slower rate and thus reduces the overshoot that would otherwise be too high for the power transistor to sustain.

In one example, the voltage sensing circuit is connected directly to the gate driver. In one example, the voltage sensing circuit is integrated with the gate driver integrated circuit.

Detecting the overcurrent typically includes retrieving an overcurrent detection threshold from a lookup table stored in the memory, and determining whether the current measured at sensors 252 is greater than the retrieved overcurrent detection threshold. If the measured current is greater than the overcurrent detection threshold, then the soft turn-off may be performed. If the measured current is not greater than the overcurrent detection threshold, the soft turn-off may not be performed.

Additionally, or alternatively, the overcurrent detection threshold is dynamically adjusted in tandem with the gate drive strength based on an expected current level in the power transistor. In one example, the overcurrent detection threshold is increased when the gate drive strength increases. In another example, the overcurrent detection threshold is decreased when the gate drive strength decreases. The gate drive strength may change in response to battery state of charge (SOC), vehicle load, temperatures, and the like.

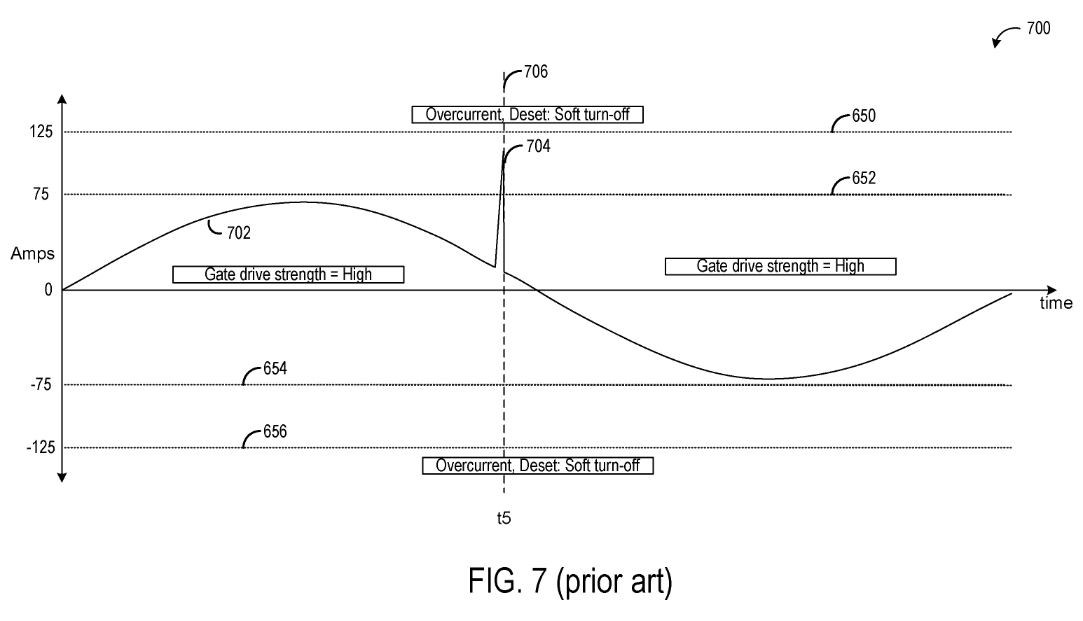

The overcurrent may be related to the gate drive strength, as depicted in FIGS. 6 and 7, according to the prior art. Referring first to FIG. 6, a first exemplary current graph 600 shows a switching cycle of an inverter such as inverter 122 of vehicle 100 of FIG. 1, plotted over time, with an amplitude in amps indicated on a vertical axis. Current graph 600 includes a current plot 602, which shows an oscillation of an expected current during operation of the inverter. Over one switching cycle, an amplitude of the expected current oscillates from zero to 100A at a first time t1 indicated by a dashed line 620; back to zero at a second time t2 indicated by a dashed line 622; to -100A at a third time t3 indicated by a dashed line 624; and back to zero at a fourth time t4 indicated by a dashed line 626. Current graph 600 also includes a maximum current plot 604, which shows an oscillation of a maximum permitted current during operation of an inverter. The maximum permitted current peaks at a point 606 at time t1, when the maximum permitted current is 125A, and again at a point 608 at time t3, when the maximum permitted current is -125A. Thus, maximum current plot 604 shows 125% of the expected true maximum phase current, allowing for tolerances.

As described above, the gate drive strength applied to the power transistors of the inverter may be modulated to reduce switching losses for different instantaneous phase current ranges. In FIG. 6, a first gate drive strength is applied when the current amplitude is between 75A, indicated by a dotted line 652, and -75A, indicated by a dotted line 654, where the first gate drive strength is a higher gate drive strength. A second gate drive strength is applied when the current amplitude is greater than 75A (e.g., above line 652) or less than -75A (e.g., below line 654), where the second gate drive strength is a lower gate drive strength. A low gate drive strength may be achieved by using a greater ohmic value for the gate resistor if the gate drive circuit has a voltage output. Also, low gate drive strength may be achieved by using a lower drive current if the gate driver has a current output to the power transistor. Reducing the ohmic value of a voltage-driven gate resistor will increase the drive strength (faster switching of the power transistor). Increasing the current output of a current-driven gate drive will also increase the drive strength. The overcurrent detection level is modulated in tandem with the gate drive strength based on the expected current level in the power transistor. These levels of overcurrent detection and gate drive strength can change multiple times during the fundamental period (using two distinct levels of gate drive strength and overcurrent there may be four times where these levels would change in a fundamental period). The gate drive strength levels may be selected based on various signals, such as a phase current level, a semiconductor temperature, a drain voltage of a last switching cycle, etc. In FIG. 6, the first and second gate drive strengths are selected such that a transition between the higher and the lower gate drive strengths occurs at 75% of the maximum expected current. It should be appreciated that while in FIG. 6 two gate strengths are depicted, in other embodiments, a greater number of gate strength levels may be used during operation of the inverter.

A current detector (e.g., peak detector 615) may detect a first overcurrent in current measurements acquired from a current sensor (e.g., current sensor 252), meaning, when the measured current shown by plot 602 exceeds the peak maximum current predicted at points 606 and 608. That is, the first overcurrent may be detected when a positive peak 610 rises above a dotted line 650 indicating the maximum permitted current of 125A at point 606, and/or when a negative peak 612 falls above a dotted line 656 indicating the maximum permitted negative current of -125A at point 608. When the first overcurrent is detected, a soft turn-off may be performed to protect the circuitry of the power transistors.

It may be noted in FIG. 6 that the first overcurrent is detected while the second, lower gate drive strength is being applied to the power transistors. As a result of the first, lower gate drive strength being applied, the soft turn-off may be performed to protect the power transistors. The first, higher gate drive strength is applied when the measured current is within 75% of the maximum expected current and the likelihood of an overcurrent is low.

FIG. 7 shows a second graph 700, which includes a plot 702 of a measured current similar to plot 602 of FIG. 6. In plot 702, the measured current does not increase above 75A indicated by line 652 or decrease below -75A indicated by line 654. However, at a time t5, indicated by a dashed line 706, the measured current increases rapidly, causing a second overcurrent 704. In contrast with the first overcurrent, second overcurrent 704 may be caused by an isolation fault, rather than an variance in current. The measured current at second overcurrent 704 is above the maximum expected current of 75A indicated by line 652. However, second overcurrent 704 occurs at a time when the first, higher gate drive strength is being applied to the power transistors. Further, the measured current at second overcurrent 704 does not exceed the maximum permissible current of 125A indicated by line 650. As a result of not exceeding the maximum permissible current, the soft turn-off mode may not be initiated. However, the gate drive strength may be too high to perform a hard turn-off of the current. A voltage overshoot may be generated that exceeds a maximum permitted voltage, and the power transistor may degrade.

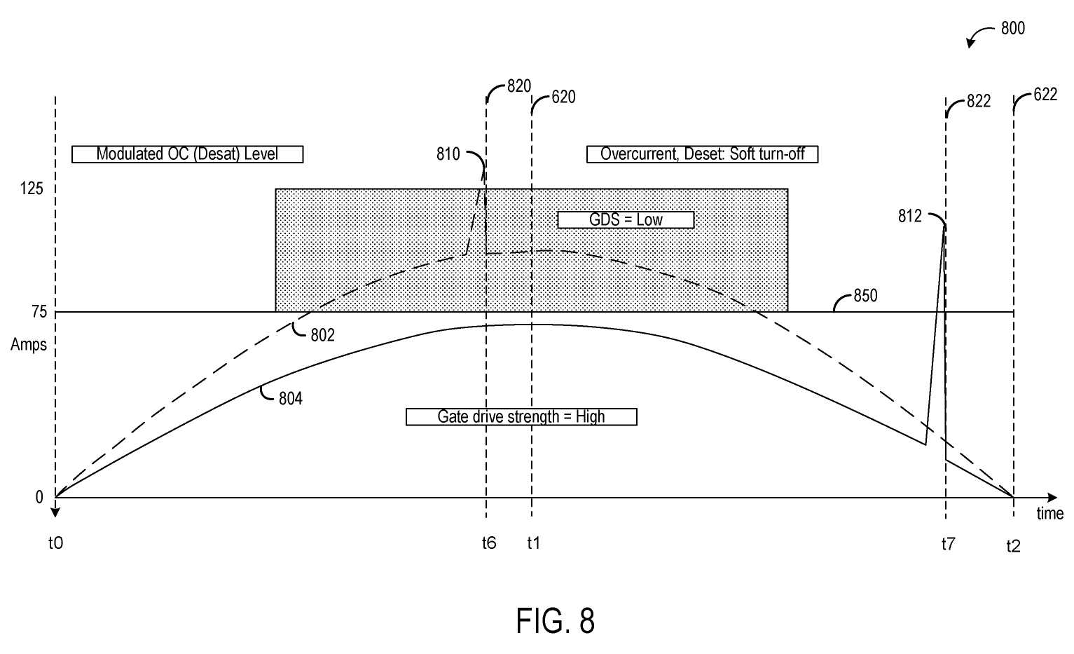

To avoid this situation, the overcurrent detection threshold may be dynamically set based on a gate drive strength at gate driver 218. That is, rather than relying on a fixed, predefined overcurrent detection threshold, an overcurrent detection threshold may be selected dynamically during each switching cycle, based on the gate drive strength. For example, the overcurrent detection threshold may be selected from a plurality of overcurrent detection thresholds stored in the lookup table in memory. An example of this is shown in FIG. 8.

Referring to FIG. 8, a third exemplary current graph 800 is shown, which includes two plots similar to plot 602 and 702 from FIGS. 6 and 7, respectively, but with a single peak current between time t0 and time t2. Current graph 800 includes a plot 802, which shows a measured current that generally remains within the expected current values (e.g., under 100A). However, at a time t6 indicated by a dashed line 820, a third overcurrent 810 is generated, for example, as a result of an isolation fault. Current graph 800 also includes a plot 804, which shows a measured current that generally remains under 75A, until a time t7 indicated by a dashed line 822, when a fourth overcurrent 812 is generated, as in FIG. 7.

In contrast with FIGS. 6 and 7, where the soft turn-off is generated as a result of the measured current exceeding the fixed overcurrent detection threshold indicated by line 650, in FIG. 8, a variable overcurrent detection threshold is selected based on gate drive strength, in accordance with a line 850. That is, when the gate drive strength is lower (e.g., the second gate drive strength), the soft turn-off is initiated when the measured current exceeds 125A (as in FIG. 6). Alternatively, when the gate driver strength is higher (e.g., the first gate drive strength), the soft turn-off is initiated when the measured current exceeds 75A. Thus, when third overcurrent 810 occurs, the soft turn-off is performed, as may occur conventionally in accordance with FIG. 6. Additionally, when fourth overcurrent 812 occurs, the soft turn-off is performed, as a result of fourth overcurrent 812 exceeding the lower current threshold of 75A (in accordance with line 850). This is in contrast with the scenario of FIG. 7, where the soft turn-off is not performed due to the measured current not achieving the maximum allowed current of 125A.

In this way, the overcurrent detection threshold is dynamically set at a maximum desired current level for the drive strength used. As a result, a hard turn-off may be performed at any current level, and exceeding the maximum desired current level will trigger a soft turn-off, where a resulting voltage overshoot is still controlled. The detection of the overcurrent and controlling of the soft turn-off is described in greater detail below in reference to FIG. 5.

Turning now to FIG. 3, it illustrates an exemplary power module 300 comprising an integrated circuit with a pair of power semiconductors 338 in a half-bridge arrangement, as may be used according to embodiments, and a temperature sensing element 322. The power module 300 may comprise, for example, a pair 338 of MOSFETs arranged in a half-bridge, with each MOSFET comprising, as shown, a gate (G) adapted to control (using low voltage (gate driver) circuitry) current flow between a source (S) and a drain (D), an intrinsic diode (also called body diode) between the source and drain and a separate Schottky Barrier Diode also between the source and the drain (and in parallel with the Schottky diode) to reduce switching losses. The current between source and drain (Ids) comprises a junction current; in a module, if multiple chips of MOSFETs are connected in parallel, the resulting Ids of the power switch is the sum of the multiple chips junction current. The voltage between source and drain (Vds) comprises a junction voltage. The on-state of the MOSFET comprises the conditions whereby, in response to (low voltage) input signals to the gate, the switch is in an on condition such that (high) current flows between the source and drain. An on-state resistance (Rds(on)) of the junction comprises the on-state junction voltage (or conduction voltage) divided by the on-state current or conduction current, or Rds(on) = Vds/Ids. In some embodiments, a junction temperature (e.g., the temperature of the region between the gate, source, and drain, and represented schematically nearest to the arrow (representing, in this case, an n-channel MOSFET) in each of the MOSFET in the pair 338) may be estimated by measuring the temperature-dependent characteristic (e.g., Rds(on) in the case of a MOSFET, and Vce(sat) in the case of an IGBT), and then calculating the junction temperature (using a transfer function that relates the temperature-dependent characteristic to estimated junction temperature). In other embodiments, the junction temperature may be estimated in a different manner, or measured via a different sensor.

Custom sampling circuitry 208 may be used to measure the on-state junction voltage, or conduction voltage, of the transistor. For example, with respect to FIG. 3, voltage sampling circuitry 208 may comprise circuitry adapted to sense the voltage difference between a drain pin 304 and source pin 308. The conduction current, in some embodiments, is available via a current sensor 252, which may be realized in any of a number of methods. Options for current sensing in automotive traction inverter applications may comprise, as examples, Hall-effect sensors, flux-gate sensors, current transformers, and/or shunt resistors. Phase current sensing for a traction motor such as motor 124 may comprise, for example, in-line motor phase current sensing accomplished using a shunt resistor, e.g., in phase current conductors 224, 226, and 228. The voltage drop across the shunt resistor is sensed by a sensor device with isolation so as to provide low voltage sensor signals (from the high voltage / high current phase current conductors) to the processor 220, whereby sensed conduction current (Ids) (or overcurrent) is calculated using a transfer function of the current sense signal.

As shown in FIG. 3, the pair 338 of MOSFETS include consecutively numbered pins / pinouts 1, 2, 3, 4 on the rights side, and 5, 6, 7, 8, 9 on the left side; and the NTC type thermistor 322 includes pins / pinouts 10 and 11. The NTC thermistor 322 comprises a pair of leads 320 and 318 and provides a resistance that decreases with increased temperature (of the region of the die proximate to the thermistor device/element). The thermistor, therefor, provides for sensing a temperature of the die (by using a processor to compute the temperature using a (non-linear) relationship between resistance and temperature). In other embodiments, the temperature may be measured via a different sensor.

One or more pair 338 of MOSFETs may be used in the inverter 202. For example, one or more of the pairs 238, 240, and 242 may each comprise a pair of power transistors 338 shown in a half-bridge arrangement of the power module 300. The half-bridge arrangement 206 in FIG. 2 may, for example, comprise the pair 338 shown in FIG. 3. In the exemplary module 300, all the pins on the left side (pins 7 (306), 9 (310), 8 (312), 6 (314), 5 (316)) are small current signals, connectable to the gate driver, and the pins on the right side comprise the power terminals, such as pin 1 (304). In such a configuration, the gates 310 and 314 may be electrically connected with gate driver 218; pin 306 is a low current pin and is used by the gate drive circuit; pin 1 on FIG. 3 is the power terminal and may be connected at 232 (inverter DC + link). Connection point 230 may differ from connection point 232, where 230 may comprise the DC power input of the inverter input and may be connected at 232 (DC + link bus in the inverter). Pin 324 may be connected to the gate driver. Pin 5 (reference 316) may be connected to the gate driver. Pin 2 (reference 324) may be connected with connecting point 246, and pin 3,4 (reference 308) may be connected to motor (load) phase current conductor 224. An additional pair 338 may be similarly electrically connected for pairs 240 and 242, for connections to motor (load) phase current conductors 226 and 228, respectively. In this way, the inverter 202 may comprise six MOSFETs in a three-phase bridge arrangement so as to receive DC from the battery 130 and provide AC phase current to the motor 124.

As referenced above, a half-bridge boost DC-DC converter from the battery to the inverter circuitry 204 may be realized by replacing the connections from terminal 248 to connection point 230 and from terminal 250 to connection point 244, and inserting a pair of power transistors such as pair 338. For example, battery terminal 248 may be electrically connected with pin 8 (reference 312), and battery terminal 250 may be electrically connected with pin 5 (reference 316); and pin 1 (reference 304) may be electrically connected with connecting point 230, and pin 2 (reference 324) may be electrically connected with connecting point 244. In this way, DC from the battery terminals 248 and 250 is stepped up to DC delivered to inverter circuitry at connection points 230 and 244.

Turning now to FIG. 4, a perspective view of an inverter module 400 is shown, which depicts an arrangement of power transistors for an inverter according to embodiments, and that includes a discrete temperature sensing element 414. The discrete temperature sensing element 414 may comprise, for example, a thermistor, shown having a 3D cylindrical body with leads 434 and 432 extending opposite ends of the thermistor body. The leads 434 and 432 may be soldered to the board 430. Wire bonds 412 may connect to tabs extending from a ceramic substrate comprising the board.

The exemplary inverter module 400, as shown, comprises a case 424 having a top edge 436 opposite a bottom edge 438, establishing a depth (or height) of the case 424 that extends between 436 and 438. The case 424 is shown having a width between sides 440 and 442, and a length between reference 436 and reference 424. Within the case 424 are six similarly illustrated IGBTs 408, or more specifically six IGBT dies 408. Each IGBT includes emitter pads 406, or more specifically a pair of pads 406 for the IGBT collector and emitter. Each IGBT includes a gate pad 404. Diode dies 410 provide diodes for each of the IGBTs. The top surface of the board comprise a top bonded copper layer patterned with conductive paths for interconnection of the IGBTs and diodes. Also shown are exemplary pins, including, for example, power emitter pin 416, Kelvin gate pin 418, and Kelvin emitter pin 420.

FIG. 5 shows an exemplary method 500 for managing incidents of excessive current being applied to power transistors of an inverter of an electric powertrain or other suitable system, such as inverter 122 of vehicle 100 of FIG. 1. The excessive currents may be generated, for example, when an isolation fault occurs in circuitry of the power transistors (e.g., power transistor pairs 238, 240, and 242). Method 500 may be performed by a processor of the vehicle, such as processor 220, based on instructions stored in a memory of the vehicle, such as memory 222.

Method 500 begins at 502, where method 500 includes measuring a current applied to the power transistors. The current may be applied from a battery (e.g., battery 130) to the inverter during operation of the vehicle. The current may be measured by a current sensor, such as current sensor 252 of FIG. 2.

At 504, method 500 includes determining a gate drive strength level that is applied to the power transistor. The levels of gate drive strength, along with the corresponding overcurrent limit, are selected programmatically via instructions stored in memory of the controller. The measured current may be close to the programed value due to the control loop actions. The maximum current intensity in the fundamental cycle may depend on the torque and speed condition of the electric motor driven by the inverter. The instantaneous current intensity where the gate drive strength and overcurrent levels are changed were determined during the design of the inverter. During operation, the current in the power transistor is continuously changing (with a sinusoidal shape of varying amplitude) but its instantaneous value determines which of the gate drive strength and overcurrent limit is chosen. At lower current, such as below line 850 of FIG. 8, a greater drive strength is selected, allowing faster switching of the power transistor and thus lower losses. The overcurrent is then selected, such as at 812 of FIG. 8, corresponding to the gate drive strength used, to protect the transistor in case of an overcurrent fault. At higher current, such as above line 850 of FIG. 8, a lower drive strength is selected, allowing slower switching of the power transistor. At high current a slower switching speed is needed to prevent the voltage overshoot on the drain of the power transistor to become too high and degrade the transistor. The overcurrent limit is selected at a higher value, such as at 810 of FIG. 8, to allow the high current without raising an overcurrent fault, unless of course there is a fault in the system.

At 506, method 500 includes retrieving an overcurrent detection threshold based on the retrieved gate drive strength level. In one example, the overcurrent detection threshold may be retrieved from a multi-input look-up table. The lookup table may define a plurality of overcurrent detection thresholds (e.g., maximum permissible current values) that may be applied for different gate drive strength levels. The plurality of overcurrent detection thresholds may be determined in advance and may be based on historical data and/or outputs of one or more models. In another example, the overcurrent detection threshold may be known based on the determined gate drive strength level. Thus, while the overcurrent detection threshold is a dynamic threshold, its value may be fixed to the gate drive strength.

At 508, method 500 includes determining whether the measured current is greater than the retrieved overcurrent detection threshold. If at 508 the measured current is not greater than the retrieved overcurrent detection threshold, then method 500 returns to 502, where the method includes continuing to measure (e.g., monitor) the current applied to the power transistors. Alternatively, if at 508 the measured current is greater than the retrieved overcurrent detection threshold, method 500 proceeds to 510.

At 510, method 500 includes initiating a soft turn-off mode, where the power transistors are shut down in a controlled and orderly manner to maintain a health of the power transistors and related circuitry. After 510, method 500 ends. In this way, the reliability of the inverter is increased by reducing the chance of inverter degradation caused by a hard turn-off.

Method 500 may be technically implemented in an inverter in various ways. Two possible implementations are shown in FIG. 9, although other implementations may alternatively be used. Referring now to FIG. 9, a first simplified circuit diagram 900 is shown describing a first implementation of an overcurrent detection circuit including a barrier 920, which may form part of an integrated circuit of a power module of an inverter, such as power module 300 of FIG. 3 and inverter 122 of FIG. 1. In accordance with the first implementation, a pulse width modulation (PWM) signal 904 is generated by a controller and sent as an input into a selectable strength gate driver 912 (e.g., gate driver 218), which generates an amplified gate signal (e.g., current) 914 used to control the switching of power transistors (e.g., power transistor pairs 238, 240, and 242) of the inverter. A second input into the selectable strength gate driver 912 is a gate strength level 902 selected by the controller. Gate strength level 902 is additionally used to determine a variable overcurrent detector threshold 906, as described above. For example, the variable overcurrent detector threshold may be determined by the controller based on at least the gate strength level 902. Variable overcurrent detector threshold 906 is an input into a comparator 910 along with a collector/drain voltage 908. The collector/drain voltage 908 being an image (e.g., indication) of the current in the power transistor, a comparison by comparator 910 with the variable threshold 906 would output a fault / soft turn-off request if the current in the power transistor is higher than the limit 906, selected by 902.

FIG. 9 includes a second simplified circuit diagram 1000 describing a second, alternative implementation of the overcurrent detection circuit that may form part of the integrated circuit of the inverter. In accordance with the second implementation, the PWM signal 904 is generated by a controller and sent as an input into the selectable strength gate driver 912, which generates an amplified gate signal 914 used to control the switching of power transistors, as in the first implementation. The gate strength level 902 selected by the controller is a second input into the selectable strength gate driver 912. Gate strength level 902 is an input into a variable divider 1004, which also receives the collector/drain voltage 908 as an input. An output of variable divider 1004 is compared with a fixed current detector threshold 1002. The purpose of the variable divider 1004 is to allow a fixed detection level 1002 to be used as part of a variable overcurrent detector, whose level is selected by 902. The collector/drain voltage 908 is an image (e.g., representation) of the current in the power transistor. The variable divider 1004, whose gain is selected by 902, provides comparator 1010 a scaled version of the power transistor current. By comparing with the fixed threshold 1002, comparator 1010 would output a fault / soft turn-off request if the current in the power transistor is higher than the programed limit according to selection 902.

The technical effect of comparing a current of a power transistor with a variable overcurrent detection threshold retrieved from a lookup table based on a drive strength of a gate driver of the power transistor to determine whether to initiate a soft turn-off of the power transistor is that an overcurrent generated by an isolation fault may be more reliably detected and mitigated.

The disclosure also provides support for an integrated circuit of an inverter, the integrated circuit comprising: a power transistor, a gate driver configured to output one of a first drive strength and a second drive strength to the power transistor, and an overcurrent detection circuit configured to interrupt a current of the power transistor in response to the current increasing above an overcurrent detection threshold, wherein the overcurrent detection threshold is selected based on the output of the gate driver. In a first example of the system,: in a first condition where the gate driver outputs a first, higher drive strength, a first overcurrent detection threshold is selected, and in a second condition where the gate driver outputs a second, lower drive strength, a second overcurrent detection threshold is selected, the second overcurrent detection threshold different from the first overcurrent detection threshold. In a second example of the system, optionally including the first example, the second overcurrent detection threshold is greater than the first overcurrent detection threshold. In a third example of the system, optionally including one or both of the first and second examples, the inverter is included in a powertrain of a vehicle having an electric motor. In a fourth example of the system, optionally including one or more or each of the first through third examples, the overcurrent detection threshold is a variable value based on the drive strength of the gate driver. In a fifth example of the system, optionally including one or more or each of the first through fourth examples, the system further comprises: a selectable strength gate driver configured to receive multiple inputs including a pulse-width modulation (PWM) from a controller, a gate strength level selected by the controller, and a result of a comparison between a drain voltage and a variable overcurrent detector threshold. In a sixth example of the system, optionally including one or more or each of the first through fifth examples, the system further comprises: a selectable strength gate driver configured to receive multiple inputs including a pulse-width modulation (PWM) from a controller, a gate strength level selected by the controller, and a result of a comparison between a fixed overcurrent detector threshold and a variable divider. In a seventh example of the system, optionally including one or more or each of the first through sixth examples, the power transistor is one of a MOSFET (metal-oxide semiconductor field effect transistor) and an IGBT (insulated gate bipolar transistor).

The disclosure also provides support for a method for an inverter, the method comprising: measuring a current applied to a power transistor of the inverter via a current sensor, determining a gate drive strength level applied to the power transistor by a gate driver of the inverter, selecting an overcurrent detection threshold based on the gate drive strength level, detecting that the measured current is greater than the selected overcurrent detection threshold, and in response, performing a controlled shutdown of the power transistor. In a first example of the method, the inverter is an inverter of a vehicle including an electric motor. In a second example of the method, optionally including the first example, the gate drive strength level is selected from a plurality of gate drive strength levels based on one or more of a phase current level, a semiconductor temperature, and a drain voltage of a last switching cycle. In a third example of the method, optionally including one or both of the first and second examples, the gate drive strength level is selected based on logic of the gate driver. In a fourth example of the method, optionally including one or more or each of the first through third examples, the gate drive strength level is selected based on instructions stored in a memory of the inverter and executed by a processor of the inverter. In a fifth example of the method, optionally including one or more or each of the first through fourth examples, selecting the overcurrent detection threshold based on the gate drive strength level further comprises retrieving the overcurrent detection threshold from a lookup table stored in the memory, based on the gate drive strength level. In a sixth example of the method, optionally including one or more or each of the first through fifth examples, the method further comprises: in a first condition where the gate drive strength level is a first, lower value: selecting a first overcurrent detection threshold, detecting that the measured current exceeds the first overcurrent detection threshold, and in response, performing the controlled shutdown of the power transistor, and in a second condition where the gate drive strength level is a second, higher value: selecting a second overcurrent detection threshold, detecting that the measured current exceeds the second overcurrent detection threshold, and in response, performing the controlled shutdown of the power transistor, wherein the second overcurrent detection threshold is lower than the first overcurrent detection threshold. In a seventh example of the method, optionally including one or more or each of the first through sixth examples, the method is implemented by a circuit comprising a selectable strength gate driver configured to receive multiple inputs including a pulse-width modulation (PWM) from a controller, a gate strength level selected by the controller, and a result of a comparison between a drain voltage and a variable overcurrent detector threshold. In a eighth example of the method, optionally including one or more or each of the first through seventh examples, the method is implemented by a circuit comprising a selectable strength gate driver configured to receive multiple inputs including a pulse-width modulation (PWM) from a controller, a gate strength level selected by the controller, and a result of a comparison between a fixed overcurrent detector threshold and a variable divider.

The disclosure also provides support for a method for controlling a power transistor of an electronics power module, the method comprising: detecting that a current supplied to the power transistor is greater than an overcurrent detection threshold, and in response, performing a controlled shutdown of the power transistor, wherein the overcurrent detection threshold is dynamically selected from a plurality of overcurrent detection thresholds based on a variable gate drive strength level applied to the power transistor by a gate driver. In a first example of the method,: in a first condition where the gate drive strength level is a first, lower value, the method comprises selecting a first overcurrent detection threshold, and in a second condition where the gate drive strength level is a second, higher value, the method comprises selecting a second overcurrent detection threshold, the second overcurrent detection threshold lower than the first overcurrent detection threshold. In a second example of the method, optionally including the first example, the method is implemented by a circuit that includes a selectable strength gate driver configured to receive multiple inputs including a pulse-width modulation (PWM) from a controller, a gate strength level selected by the controller, and a result of a comparison between a fixed overcurrent detector threshold and a variable divider.

FIGS. 1-4 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIG. 4 is shown approximately to scale.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

Those having skill in the art will appreciate that there are various logic implementations by which processes and/or systems described herein can be affected (e.g., software), and that the vehicle will vary with the context in which the processes are deployed. “Software” refers to logic that may be readily readapted to different purposes (e.g. read/write volatile or nonvolatile memory or media). The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, are also regarded as included within the subject matter of the present disclosure.

1. An integrated circuit of an inverter, the integrated circuit comprising:
a power transistor;
a gate driver configured to output one of a first drive strength and a second drive strength to the power transistor; and
an overcurrent detection circuit configured to interrupt a current of the power transistor in response to the current increasing above an overcurrent detection threshold;
wherein the overcurrent detection threshold is selected based on the output of the gate driver.

2. The integrated circuit of claim 1, wherein:
in a first condition where the gate driver outputs a first, higher drive strength, a first overcurrent detection threshold is selected; and
in a second condition where the gate driver outputs a second, lower drive strength, a second overcurrent detection threshold is selected, the second overcurrent detection threshold different from the first overcurrent detection threshold.

3. The integrated circuit of claim 2, wherein the second overcurrent detection threshold is greater than the first overcurrent detection threshold.

4. The integrated circuit of claim 1, wherein the inverter is included in a powertrain of a vehicle having an electric motor.

5. The integrated circuit of claim 1, wherein the overcurrent detection threshold is a variable value based on a drive strength of the gate driver.

6. The integrated circuit of claim 1, further comprising a selectable strength gate driver configured to receive multiple inputs including a pulse-width modulation (PWM) from a controller, a gate strength level selected by the controller, and a result of a comparison between a drain voltage and a variable overcurrent detector threshold.

7. The integrated circuit of claim 1, further comprising a selectable strength gate driver configured to receive multiple inputs including a pulse-width modulation (PWM) from a controller, a gate strength level selected by the controller, and a result of a comparison between a fixed overcurrent detector threshold and a variable divider.

8. The integrated circuit of claim 1, wherein the power transistor is one of a MOSFET (metal-oxide semiconductor field effect transistor) and an IGBT (insulated gate bipolar transistor).

9. A method for an inverter, the method comprising:
measuring a current applied to a power transistor of the inverter via a current sensor;
determining a gate drive strength level applied to the power transistor by a gate driver of the inverter;
selecting an overcurrent detection threshold based on the gate drive strength level;
detecting that the measured current is greater than the selected overcurrent detection threshold, and in response, performing a controlled shutdown of the power transistor.

10. The method of claim 9, wherein the inverter is an inverter of a vehicle including an electric motor.

11. The method of claim 9, wherein the gate drive strength level is selected from a plurality of gate drive strength levels based on one or more of a phase current level, a semiconductor temperature, and a drain voltage of a last switching cycle.

12. The method of claim 9, wherein the gate drive strength level is selected based on logic of the gate driver.

13. The method of claim 9, wherein the gate drive strength level is selected based on instructions stored in a memory of the inverter and executed by a processor of the inverter.

14. The method of claim 13, wherein selecting the overcurrent detection threshold based on the gate drive strength level further comprises retrieving the overcurrent detection threshold from a lookup table stored in the memory, based on the gate drive strength level.

15. The method of claim 9, further comprising:
in a first condition where the gate drive strength level is a first, lower value:
selecting a first overcurrent detection threshold;
detecting that the measured current exceeds the first overcurrent detection threshold, and in response, performing the controlled shutdown of the power transistor; and
in a second condition where the gate drive strength level is a second, higher value:
selecting a second overcurrent detection threshold;
detecting that the measured current exceeds the second overcurrent detection threshold, and in response, performing the controlled shutdown of the power transistor;
wherein the second overcurrent detection threshold is lower than the first overcurrent detection threshold.

16. The method of claim 9, wherein the method is implemented by a circuit comprising a selectable strength gate driver configured to receive multiple inputs including a pulse-width modulation (PWM) from a controller, a gate strength level selected by the controller, and a result of a comparison between a drain voltage and a variable overcurrent detector threshold.

17. The method of claim 9, wherein the method is implemented by a circuit comprising a selectable strength gate driver configured to receive multiple inputs including a pulse-width modulation (PWM) from a controller, a gate strength level selected by the controller, and a result of a comparison between a fixed overcurrent detector threshold and a variable divider.

18. A method for controlling a power transistor of an electronics power module, the method comprising:
detecting that a current supplied to the power transistor is greater than an overcurrent detection threshold, and in response, performing a controlled shutdown of the power transistor;
wherein the overcurrent detection threshold is dynamically selected from a plurality of overcurrent detection thresholds based on a variable gate drive strength level applied to the power transistor by a gate driver.

19. The method of claim 18, wherein:
in a first condition where the variable gate drive strength level is a first, lower value, the method comprises selecting a first overcurrent detection threshold; and
in a second condition where the variable gate drive strength level is a second, higher value, the method comprises selecting a second overcurrent detection threshold, the second overcurrent detection threshold lower than the first overcurrent detection threshold.

20. The method of claim 18, wherein the method is implemented by a circuit that includes a selectable strength gate driver configured to receive multiple inputs including a pulse-width modulation (PWM) from a controller, a gate strength level selected by the controller, and a result of a comparison between a fixed overcurrent detector threshold and a variable divider.
